(19) United States
(12) Patent Application Publication
(10) Pub. No.: US 2004/0229560 A1
(43) Pub. Date: Nov. 18, 2004

(54) Methods of tracking and verifying human assets

(76) Inventor: William C. Maloney, Atlanta, GA (US)

Correspondence Address: Womble Carlyle Sandridge & Rice, PLLC, P.O. Box 7037, Atlanta, GA, 30357-0037, US

(21) Appl. No.: 10/684,028

(22) Filed: Oct. 10, 2003

Related U.S. Application Data
(60) Provisional application No. 60/417,570, filed on Oct. 10, 2002.

(51) Int. Cl. H04H 1/00

(52) U.S. Cl. 455/3.01

(57) ABSTRACT

A human asset tracking and monitoring methodology is provided for tracking and monitoring the locations and movements of individuals in a monitored area. One application of the method is the tracking and monitoring of employees within a work environment such as an office or factory. The method includes providing each employee with an electronic radio frequency personal event tracking (PET) tag. Each PET tag is uniquely identified with an ID code. Area readers located throughout the monitored facility are configured to communicate with PET tags within their radio frequency ranges. The area readers are coupled to a host server for sending information to and receiving information from the server. The area readers detect the presence of PET tags, and thus their wearers, within various zones of the monitored area and communicate this information to the host server. The hose server logs the locations and movements of employees based upon communications from the area readers, compiles statistics, provides or denies access to restricted areas, and performs a number of other valuable functions.

### REFERENCE TO RELATED APPLICATION

Priority is hereby claimed to the filing date of U.S. provisional patent application serial No. 60/417,570 filed Oct. 10, 2002.

### TECHNICAL FIELD

This invention relates generally to methods and systems for tracking and controlling the activities and movements of individuals and more specifically to automated radio frequency systems and methods for tracking and controlling individuals such as employees in a work environment.

### BACKGROUND

Tracking the activities of employees in a work environment has long been one of the functions of management and human resource managers. For example, in a large office and/or manufacturing facility, it is highly desirable to be able to locate employees quickly when they are needed to, for instance, respond to customers or colleagues. One common method of achieving this has been to page the employee over a audio paging system. Paging, however, does not identify, the actual location of the employee and does not provide tracking information about the employee's movement.

Insuring security within work environments also has long been a problem for management. Specifically, in most work environments, there are areas to which certain employees have authorized access but others do not. Insuring that unauthorized personnel do not access restricted areas has been addressed in a variety ways including, for example, the posting of guards, the use of entry keypads, the installation of ID badge swipers, and installation of biometric sensors, such as fingerprint scanners, coupled to the locking mechanisms of doors to restricted areas. While these methods have been somewhat successful, they nevertheless have certain inherent problems. For instance, where badge swipers are used, the system can be defeated with a stolen or exchanged employee badge. Codes to keypad security systems can be compromised and the posting of guards is subject to human error and misjudgment. Thus, prior security measures have not been completely reliable.

In a broader sense, there has not heretofore been a reliable method of continuously tracking the movements and whereabouts of employees within a work environment. Such data, if available, can be extremely valuable to management in accessing, for example, inefficient work patterns, inefficient employees, total time spent on station, time spent on breaks and meals, and other employee statistics.

Thus, a need persists for a reliable and virtually fool proof method and system for tracking human resources within the work place that addresses the problems and shortcomings of the prior art. Such a method also should provide continuous tracking of employees for the development of valuable workplace statistics and should be immune from tampering and defeat by unscrupulous individuals. It is to the provision of such a method and system that the present invention is primarily directed.

### SUMMARY OF THE INVENTION

Briefly described, the present invention is a method and system for monitoring and recording the movements of individuals throughout a monitored facility or campus, such as in the workplace. The system is based upon Personal Event Tracking (PET) tags, one of which is work by each individual to be tracked, that can transmit and receive information via radio transmissions. Area readers, also incorporating radio frequency transceivers, are located throughout a monitored area in strategic locations. Each area reader is designed to communicate with PET tags located within its range and to convey gathered information from PET tags to a host server for processing. At a top level, the locations of PET tags, and thus the locations of employees wearing them, can be determined by the host server continuously by analyzing the information from the various area readers. Other valuable functions and features are incorporated into the system and method, as explained in greater detail below.

The host server maintains databases that list which users are authorized for certain rooms or areas of the facility. The system can unlock doors to allow authorized personnel access these areas or rooms and can sound alarms and/or notify security personnel if unauthorized personnel gain or attempt to gain access. The flexibility of the system allows these authorization databases to specify which individuals can access which secure areas during what hours of the day.

One important byproduct of monitoring the movement of individuals is that the system can be used to determine the location of any individual at any time. Moreover, the granularity of the localization scales with the amount of deployed scanning equipment. For example if area readers are placed in each cubical of a workplace, then the location of an individual can be resolved down to the cubical level.

Another byproduct of monitoring the location and movements of individuals is that the system can determine if personnel are spending too much time in certain areas (such as a dining room) and prompt them that it is time to leave the area. In addition, logs of movement data can be used for time reporting and employee efficiency studies.

The system also incorporates failsafe mechanisms to prevent fraud and deception by, for instance, the exchanging of PET tags by employees. Specifically, each PET tag incorporates a biometric sensor such as a fingerprint reader. At designated and/or random times, an employee's PET tag prompts for an identification, which required the employee to place a thumb or finger on the fingerprint reader. The PET scans the fingerprint to insure that the individual wearing the PET tag is actually the individual assigned to that particular PET tag. In the event of an improper reading, the host server is notified and appropriate remedial action can be taken.

Thus, a unique method and system is now provided that addresses the shortcomings of the prior art by providing reliable, continuous, and tamper proof tracking and monitoring of the locations and movements of large numbers of individuals in a monitored facility. The system provides valuable efficiency statistics, controls access to restricted areas automatically, and performs a number of other functions described in greater detail below. These and other objects, features, and advantages of the invention will be appreciated better upon review of the detailed description set forth below taken in conjunction with the accompanying drawing figures, which are briefly described as follows.

### BRIEF DESCRIPTION OF THE DRAWINGS

FIG. 1 is a simplified plan view of a typical monitored facility showing possible various types and locations of area monitors within the facility according to the invention.

FIG. 2 is a functional diagram illustrating the various components and functions that make up a PET tag according to the invention.

FIG. 3 is a simplified plan view illustrating application of the method of this invention to the problem of tracking and monitoring parolees.

FIG. 4 is a functional chart illustrating the various communication paths and relationships between components of a human asset tracking and monitoring method and system according to the invention.

FIG. 5 is a plan view of a monitored area illustrating overlapping of the transceiver ranges of a plurality of area readers in a monitored area.

FIG. 6 is a plan view of a monitored area illustrating another configuration of overlapping transceiver ranges of a plurality of area readers in a monitored area.

FIGS. 7-12 comprise a flowchart illustrating a preferred embodiment of the method of the invention and the best mode of carrying out the inventive method.

FIGS. 13-18 illustrate the functioning of the method of the invention in a variety of scenarios.

FIG. 19 is a perspective view of a preferred embodiment of a PET tag that embodies principles of the invention in a preferred form.

FIG. 20 is a functional block diagram illustrating the various elements of an area reader according to principles of the invention.

FIG. 21 is a front plan view of a preferred embodiment of an area reader according to the invention.

### DETAILED DESCRIPTION OF THE PREFERRED EMBODIMENTS

The invention will now be described in detail with reference to the drawing figures described above. The method of the invention is described largely in terms of examples of the operation of the system in a variety of scenarios to which the application is applicable.

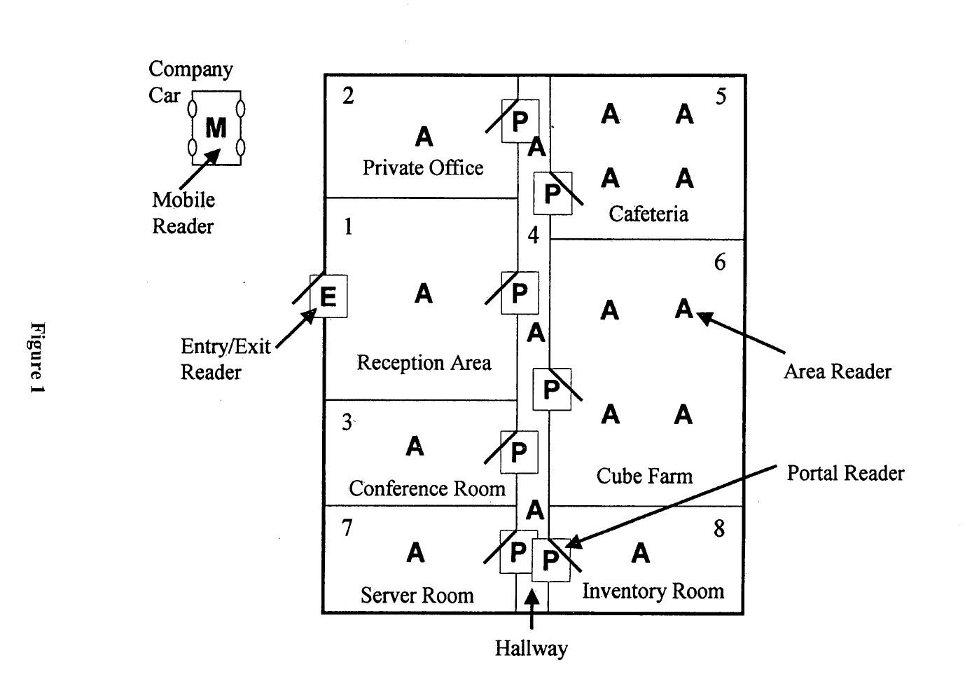

A schematic illustration of the people tracking system is shown in FIG. 1. A typical office building will consist of many regions. FIG. 1 shows a simple 8-region office setting. For example, region 1 is the reception area, region 2 is a private office, region 3 is conference room, region 4 is a hallway, region 5 is cafeteria, region 6 is a common cube farm, region 7 is the server room, and region 8 is the inventory room. The passageways and doorways between regions are called portals. One goal of the people tracking system is to continually monitor and update the location of all employees while inside the building. This is accomplished by each employee being equipped with a personnel event tracking (PET) tag and by placing area readers in each region and portal through out the building. As shown in FIG. 1, region area readers are denoted with an A, portal readers are denoted with a P, and entry/exit points are denoted with an E. In general, a region reader is designed to monitor a large area of office space while a portal reader is designed to only monitor a very limited area at the portal. The entry/exit reader is similar to a portal reader but also incorporates I/O to gather destination data; for example, going to lunch, going home, etc.

Each reader (region, portal and entry/exit) is connected to a host server through a local area network (LAN). The host server is responsible for maintaining the database of current and past history of user location data. A workstation, for example the receptionist's workstation, can access the current location data to help locate personnel.

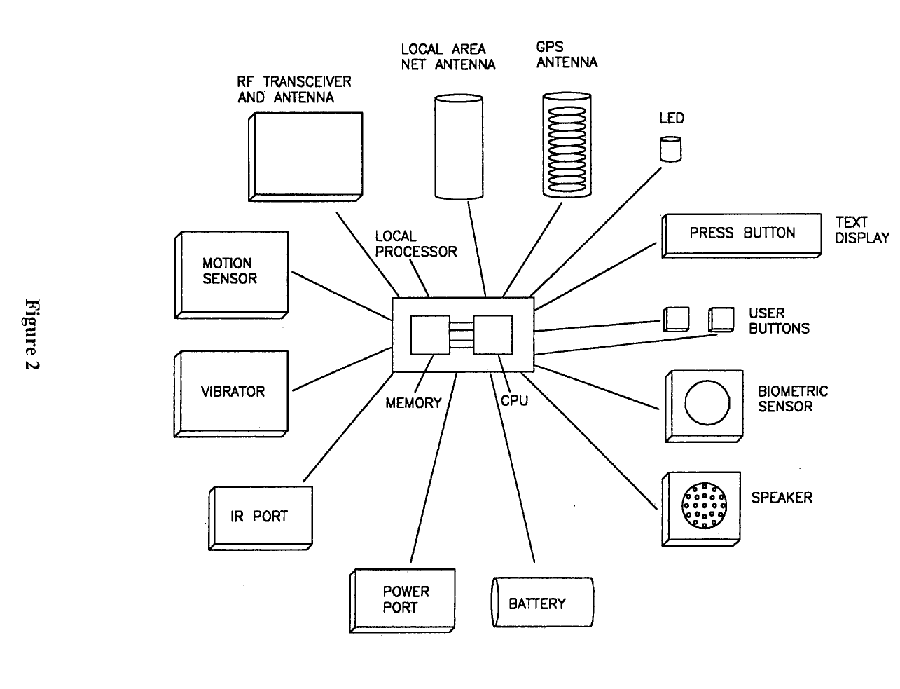

A functional description of a PET tag is shown in FIG. 2. At the core of the PET tag is a micro-controller with associated components; such as memory, etc. The PET tag is powered by a battery and contains a recharging port. The micro-controller is attached to a display, and buttons are utilized for user I/O. User identity is authenticated using a biometric sensor. Other envisioned output mechanisms include a speaker, a vibrator, and an LED. The PET tag communicates with the various PET readers using a PET transceiver antenna. The PET tag can also contain a GPS antenna to determine physical location, and a motion sensor to ensure the PET tag is being worn. Furthermore, a high-speed data communication port for software upload and mass data exchange is envisioned.

Employee Tracking Example:

To illustrate the general functionality of the people tracking system, consider the following fictional employee workday. When the employee arrives at the office, he approaches the entry/exit portal and enters the reception region, denoted 1 in FIG. 1. During normal working hours, the entry/exit portal is typically unlocked. Upon entering the building, the employee's presence in region 1 is detected by the region 1 reader and logged in the host server database. The host server relays an authorization request to a PET tag through the region 1 reader. The employee validates his identity by using the biometric sensor of his PET tag. This prevents unauthorized personnel from using someone else's PET tag.

When the employee approaches the portal between the reception region 1 and hallway region 4, the portal reader senses the employees PET tag. If the user has been authenticated, the portal reader will unlock the portal for the employee. As the employee enters the hallway, he turns right and the presence of his PET tag is noted by the region 4 area readers and his location is logged with the host server.

The employee is heading to his cubical in region 6. As he approaches the portal from region 4 to the cube farm in region 6, the portal reader senses the employees PET tag. Since the employee is authorized to enter the cube farm, the portal is automatically unlocked. As the employee enters the cube farm, the presence of his PET tag is noted by the region 6 area readers and his location is logged with the host server.

The employee logs into his computer and checks his email. After checking his email, he leaves region 6, passing through region 4 on his way to the cafeteria region 5. As the employee leaves region 6 and enters region 4, the presence of his PET tag is noted by the region 4 area readers and his location is logged with the host server. The host server using the log of previous region data determines that the employee has left his work area. The host server sends a command to the employee's workstation to log the employee out if he forgot. This ensures that no unauthorized personnel can access the IT infrastructure by using machines inadvertently left logged in.

As the employee enters the cafeteria, the region 5 area readers note the presence of his PET tag and his location is logged with the host server. While the employee is having coffee and eating breakfast, a phone call comes in for the employee. Because the employee is not at his desk, the call rolls over to the receptionist. The receptionist queries the host server to find out if the employee is inside the facility. The host server indicates the employee is in the cafeteria. The receptionist enters a command to the host server to notify the employee that he has a phone call. The host server relays the command to the region 5 area reader. The region 5 area reader relays the information to the employee's PET tag. The micro-controller in the PET tag causes the speaker to chirp and uses the text display to tell the employee that he has a phone call on extension 202. The employee can then use a phone in the cafeteria to pick up extension 202 and promptly handle the phone call. Of course, the receptionist could be replaced with a voice mail system that informs the caller that the employee is being paged.

After handling the important phone call, a package is received by the receptionist for the employee. Again, the receptionist uses the host server to inform the employee that he has a package at the front desk.

After finishing his coffee and picking up his package, the employee goes to the inventory room (region 8) to get some important files. As the employee approaches the portal to the inventory room, the presence of his PET tag is sensed by the portal reader. Since the inventory room is considered a high security area, the portal reader relays an authentication request to the PET tag. The employee validates his identity by using the biometric sensor of his PET tag. After authentication is complete, the portal reader automatically unlocks the door, and the employee enters the inventory room. The presence of his PET tag is noted by the area reader inside the inventory room and his location is logged with the host server.

After leaving the inventory room, the employee stops by the server room to complain that the server is down. As he approaches the server room door, the portal reader senses the presence of his PET tag. Since the employee is not authorized to enter the server room, the portal reader signals the PET tag that entry is prohibited, and the PET tag notifies the user by buzzing the speaker and displays the entry prohibited message on the text display. The employee really wants to know when the server is coming back up, so he knocks on the door. A server room employee hears the knocking, and approaches the portal from the inside. The portal reader senses the PET tag of this authorized server room employee, and unlocks the portal. The server room employee opens the door and lets our employee enter. The server room area reader then senses both employees' PET tags as they move into the server room. Because the one employee is not authorized to be in the server room, the host server signals the area reader to perform the visitor override procedure. The area reader signals each PET tag to perform visitor override. The micro-controller on each PET tag buzzes the speaker and notifies the user that an un-authorized person has entered the area. Each user needs to use the biometric sensor on his PET tag to notify the area controller that he is aware of the un-authorized visitor.

After leaving the inventory room, the employee goes to the morning staff meeting in the conference room (region 3). As he approaches the conference room, the portal reader senses his PET tag, and because he is authorized to enter the conference room, it unlocks the door. As he enters the conference room, the area reader senses his PET tag and logs his location with the host server. Randomly throughout the day, the host server selects employees for authentication. This random checking is designed to catch employees who try to leave the PET tag with a co-worker while they leave the office. The co-worker will not be able to respond to the random request for authentication and thus the employee will be caught. During the meeting, our employee is selected at random by the host server for an authentication check. The host server relays this authentication check request to the area reader. Because this is a conference room where a meeting could be in progress, the area reader relays the authentication check request to the PET tag with a silent flag. The micro-controller notifies the user of the silent authentication request by activating the vibrator and displays the request on the text display. The employee performs the authentication procedure using the biometric sensor on his PET tag.

Because of the potential existence of dead spots inside facility, the PET tag will also randomly prompt the employee for authentication when the PET tag is outside the range of any readers. This PET tag driven random checking is designed to catch employees that are trying to beat the system by utilizing dead-zones or shielding their PET tag from readers. The PET tag can also sense attempts to intentionally or unintentionally shield its transceivers, and the micro-controller will buzz the speaker and use the text display to notify the user of any shielding issues.

After the morning staff meeting, the employee returns to his cube and falls asleep. The micro-controller in the PET tag uses the motion sensor to detect employees who don't move for long periods of time. Once the micro-controller notes that the user has not moved for a significant period of time, the micro-controller will buzz the speaker, activate the vibrator and use the text display to notify the employee to perform authentication. The employee will need to wake up and use the biometric sensor. This motion check would also catch any employee who takes his PET tag off and leaves it on the desk, etc. Later after working in his cube for the rest morning, the employee decides he needs lunch. He leaves the cube farm (region 6) and passes through region 4 on his way to the cafeteria. Upon entering the cafeteria, the area reader will sense his PET tag and log his location with the host server. After 1 hour in the cafeteria, the host server will prompt the area reader to notify the employee that he has exceeded the 1-hour limit. The PET tag will chirp the speaker and use the text display to notify the employee that he is exceeding the allowed 1 hour lunch.

After lunch, the employee has a sales call outside the office. As the employee is leaving the building, he approaches the Entry/Exit portal. The Entry/Exit portal includes a keypad and display screen in addition to the usual portal hardware. The Entry/Exit portal reader senses the employee's PET tag and prompts the user for destination data. This prompted I/O is context sensitive. For example, at lunchtime, the top choice is “out for lunch”. Toward the end of the day, the top choice is “leaving for the day”. The employee selects “sales call—coming back”.

Because the sales call is a company function, the employee chooses to use a company car for the trip. He goes to his designated company car. The company car contains a special mobile reader (denoted by M in FIG. 1). The mobile reader senses the employee's PET tag and requests employee authentication. The employee validates his identity by using the biometric sensor of his PET tag. This authentication prevents unauthorized personnel from using someone else's PET tag to gain use of company vehicles.

As the employee travels to and from his various sales calls, the PET tag logs his locations using the GPS antenna system. Upon returning to office, the PET tag can upload destination and time information. Depending on the volume of data, the PET tag can upload this data to the host server using the PET transceiver antenna or the high speed, data communication port. This destination and time information would be used to help log sales activity in the company sales prospecting software.

After completing the workday, the user exits the building through the Entry/Exit portal. Again, the Entry/Exit portal reader senses the employee's PET tag and prompts the user for destination data. Because it is the end of the day, the top choice is “leaving for the day”. The employee selects “leaving for the day” and goes home.

After the employee has left for the day, the host server computes total work time. Total work time is computed by subtracting time spent at lunch and on breaks in the cafeteria from the difference between start and leave time. The host server will maintain a database of employee work time for statistical analysis and activity reports.

For example, the analysis of the workday can be used to determine if employees are spending too large of a fraction of the day in meetings or the lack of meetings. Also, if one employee is spending a disproportionate amount of time in the supervisors area then the system can warn the manager that this employee is using too much of his time.

Parolee Monitoring Example:

Another envisioned application of the PET system is parolee monitoring. Criminals are conditionally-released early from prison into the parole system. The criminal must follow the strict rules of the parole system as dictated by his parole officer. These rules typically include restricted travel, prohibition from consuming alcohol and frequenting places of ill repute; e.g., gambling, etc. The functionality of the PET system is well suited for this application.

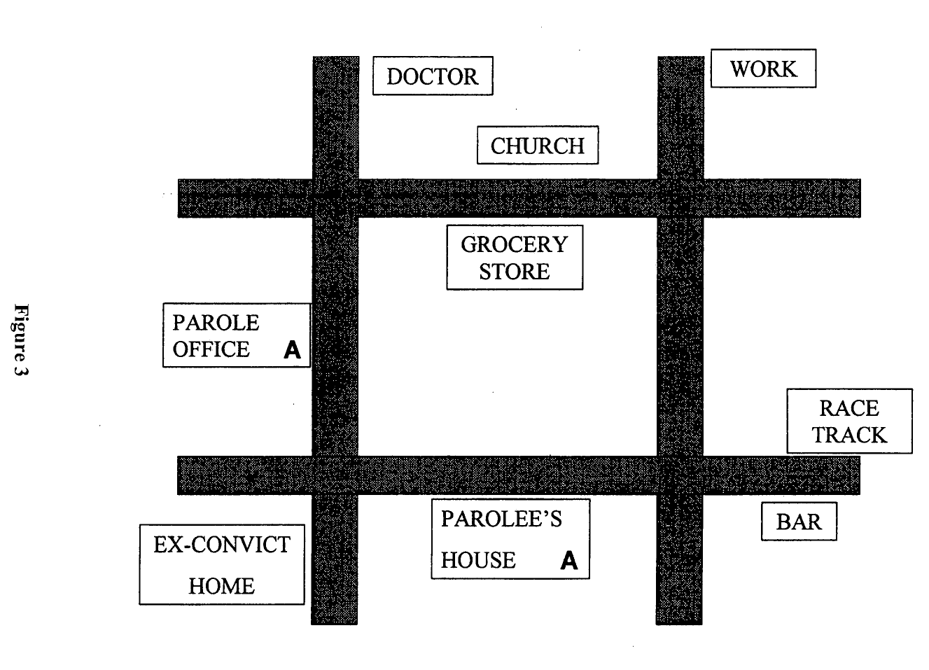

To illustrate the applicability of the PET system to parolee monitoring, consider the following fictional parolee-monitoring scenario. FIG. 3 shows the neighborhood surrounding the home of a recently released parolee. The parolee has a set schedule; he is supposed to go to work 5 days a week; he is supposed to visit his parole officer once a week, and he is supposed to avoid the bar, the race track and the homes of other ex-convicts. Basically, he is allowed freedom of movement as long as he follows the rules established by his parole officers.

In the parolee-monitoring example, the parolee is outfitted with a PET tag and his home is equipped with a home area reader (denoted H in FIG. 3). A home area reader consists of one or more PET area readers and a data-port connection (dial up, DSL, cable modem, etc). The parole office contains an area reader and a host server. Optionally, area readers can be placed at locations that the parolee will frequent (e.g. work).

During a typical day, the parolee leaves his home in the morning and goes to work. Occasionally during the week he stops by the grocery store, the church or the doctor's office. As he moves throughout the day, the PET tag logs his position using the GPS antenna system. At the end of each day, as the parolee enters his home, the home area reader senses his PET tag and uploads the log of his recent movements. The home reader then uses the data-port connection (dial-up, DSL, cable modem, etc) to upload this movement data to the host server at the parole office.

The host server will generate reports for the parole officer showing daily movements of each monitored parolee. These reports will highlight any new destinations for each parolee for inspection by the parole officer. These new destinations can be cross-referenced using accurate maps and the GPS coordinates. If the destinations correspond to prohibited locations; such as the racetrack, bar or homes of ex-convicts the parole officer can take suitable action. Also, if the parolee is not going to work or not spending the appropriate amount of time at work, the parole officer will be aware of this promptly from the PET tag daily movements logs.

One weakness of this system is potential tampering with GPS antenna system. This weakness is overcome in the following fashion. When the micro-controller in the PET tag loses the GPS signal for a predetermined amount of time, the PET tag will log a GPS anomaly event for upload when the parolee next goes home and will buzz the speaker and use the text display to inform the parolee to contact his parole officer immediately. The parole officer becomes aware of this problem either when the parolee calls in or when his PET tag movement and event logs are next synchronized with the host server. Clearly, if the parolee ignored the call-immediately message, the parole officer will become aware of this transgression and will take appropriate action.

A related application of the PET system would be home detention monitoring. Home detention is used as alternative punishment for non-violent, convicted criminals. Typically, the non-violent criminal is only allowed to leave his home to go to a small list of pre-approved destinations; e.g, his place of employment, the parole office; etc. For the home detention application, the PET tag may have to be tethered to the criminal. For example, a wristwatch sized ring that locks in place to prevent removal. The functionality of the PET tag is such that the criminal's monitor can remotely allow removal of the PET tag for short periods of time (e.g. shower) and then insure that the tag is reattached through monitoring with period requests for biometric authentication.

Functional Description:

The previous section described the various functions of the people tracking system through a couple of sample scenarios. In this section, a more detailed description of how the various components (PET tags, readers, etc) interact in the people tracking system is provided

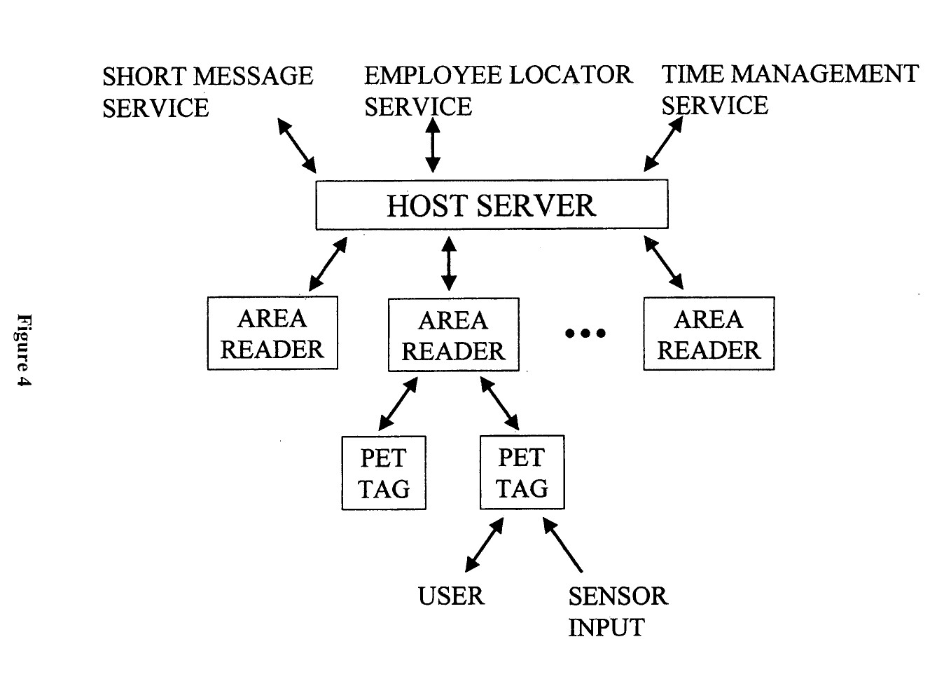

The major elements of the people tracking system are shown in FIG. 4. The major elements are the PET Tag, the various area readers, and the host server. The key to understanding the people tracking system is understanding the interactions between these elements.

PET Tag/User Interaction

At the bottom of FIG. 4 is the user. Basically, one PET tag is assigned to each user. The people tracking system can locate, monitor and communicate with each user through his PET tag. Most importantly, each PET tag has a unique ID code that provides unambiguous identification. The PET tag also has various input/output capabilities as shown in FIG. 2. For example, any messages to the user can be displayed on the PET's display. Various LEDs, speakers, and mechanical vibrators are included to help bring messages to the users attention. In addition to these output mechanisms, the PET tag can gather inputs. For example, the user can authenticate his identity using the biometric sensor. Also, the PET tag can log physical location using the GPS sensor.

Area Reader/PET Tag Interaction

The next level up in the people tracking system is the interaction between the PET tags and the various area readers. As discussed in the scenario descriptions and illustrated in FIG. 1, there are various types of area readers. These include the general-purpose area reader, the portal reader, the specific entry/exit portal reader and the mobile reader. Basically at a fundamental level, the various readers are all essentially area readers with different read ranges and a few unique features. The details of the various readers will be discussed in greater length below. Like the PET tag, each area reader has a unique ID code that provides unambiguous identification.

As the user moves around, the PET tag that he carries comes within range of various area readers. As the PET tag comes with range of a reader, the PET tag responds to the area reader that it is now present in this area. The area reader acknowledges the PET tag and logs this information with the host server. The area reader can relay any authentication requests and messages to the PET tag.

Host Server/Area Reader

As each reader acknowledges the presence of PET tags, this location information is logged with the host server. The host server maintains databases of the movements of each tag throughout the various readers. For example, using these databases, the host server can automatically generate messages to users that have been in the break room or cafeteria longer than allowed. Also, the host server can select users randomly or using some artificial intelligence algorithm for re-authentication to make sure that only proper employees are using PET tags. These messages and authentication requests are relayed through the area reader in which the PET tag is currently located.

Outside World/Host Server

The last interaction is between the people tracking system and the outside world. For example, the host server can provide several services. The first is the “employee locator services”. Using either dedicated terminals or even a web based GUI, a user could enter the name of an employee and the host server could respond with his current location using the databases of stored area data. The second is the “short message service”. For example, as described in the sample scenario, the reception could send messages to the user through the people tracking system such as “there is a visitor in the lobby”, or “phone call on x-202”. This “short message service” could be a dedicated system or tied into an internet based instant message service for greatly flexibility.

Area Reader Frequency Deployment

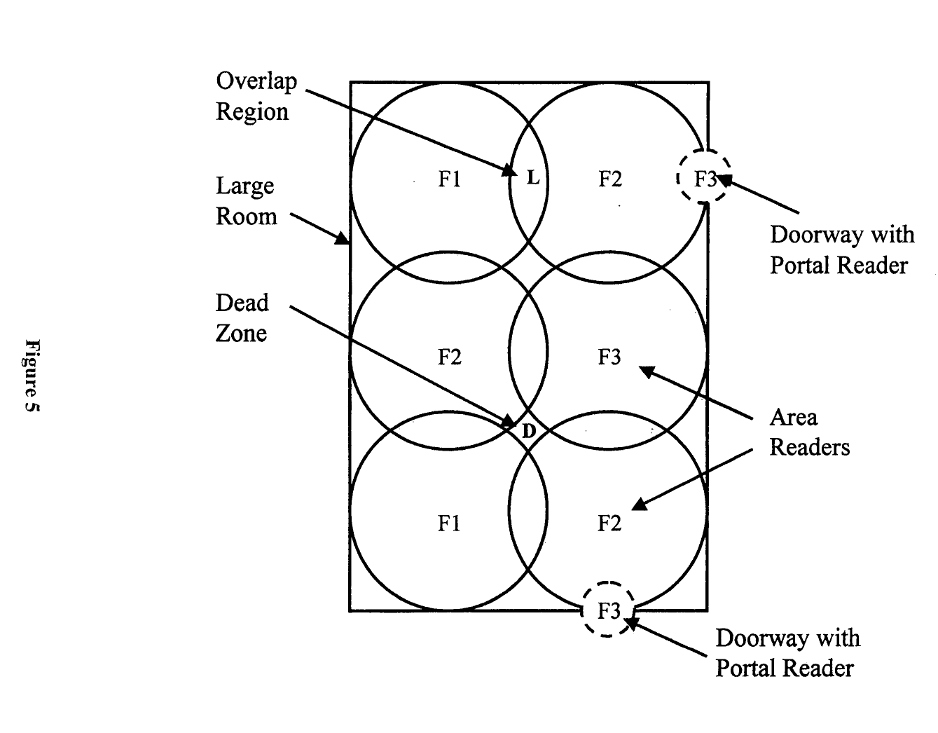

As mentioned above, the various readers at a fundamental level are all area readers. Consider the example deployment of area and portal readers for a large room with two doorways as shown in FIG. 5. The expanse of the large room will be covered with 6 area readers and each doorway will be covered with a portal reader. As shown in the figure, the read range of the various readers overlaps in portions of the room. For example, a PET tag located at location L in the FIG. 5 would be within range of both of the top two area readers. Also, a PET tag located near the top doorway would be within range of the portal reader and the top right area reader.

To avoid jammed communication, adjacent area readers are assigned different frequencies by the people tracking system. However, the number of frequencies needed is much smaller than the number of readers because the frequencies can be reused as shown in FIG. 5. The typical large room shown in FIG. 5 has 6 area readers and two portal readers but only 3 unique frequencies are used. These 3 frequencies can also be reused in the same manner throughout the facility. For many office settings, the required number of frequencies will be less 10 regardless of the office size.

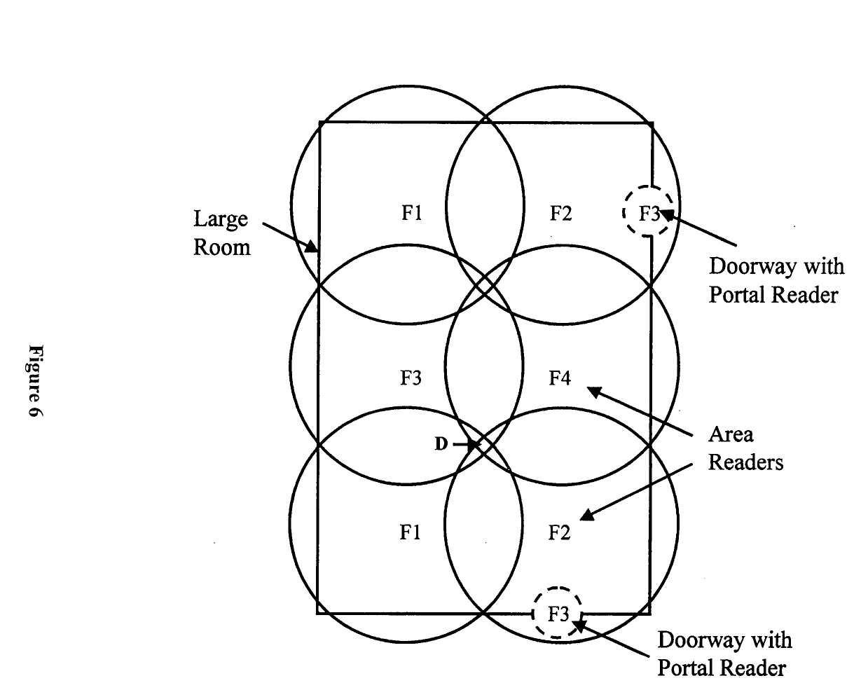

Since the range of the area readers is roughly a circular area, dead zones may also exist. For example, consider the location D in FIG. 5. At location D, a PET tag would be out of communication with the people tracking system. In general, some dead zones are inevitable and not a problem. For situations where dead zones are not desirable, the output power of the area readers can be increased which increases the read range as illustrated in FIG. 6. Now a PET tag at location D is within communication range of all four area readers. Because as many as four area readers now overlap, the minimum number of unique frequencies is four.

Detailed Description:

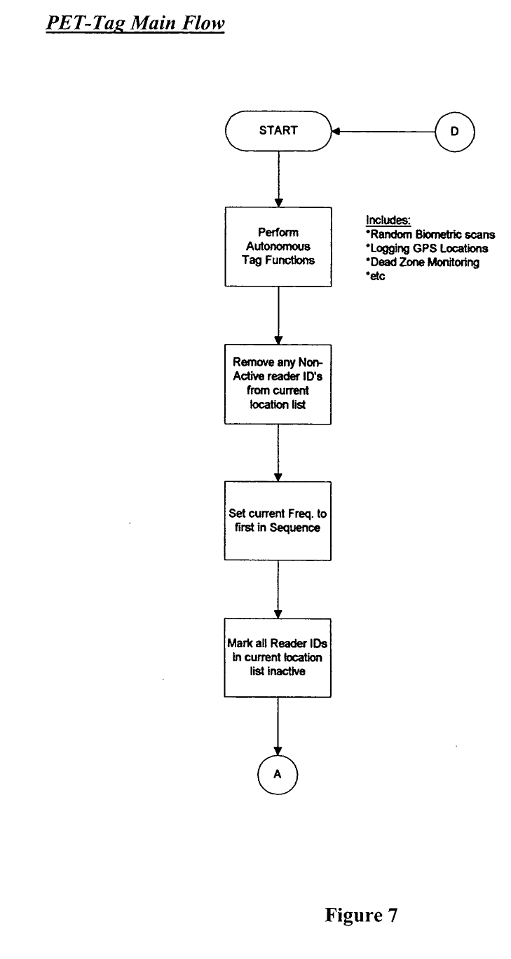

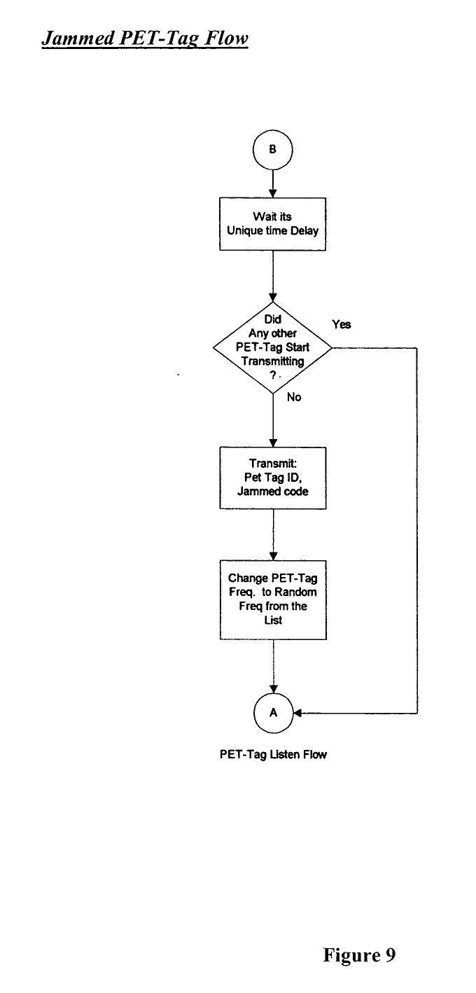

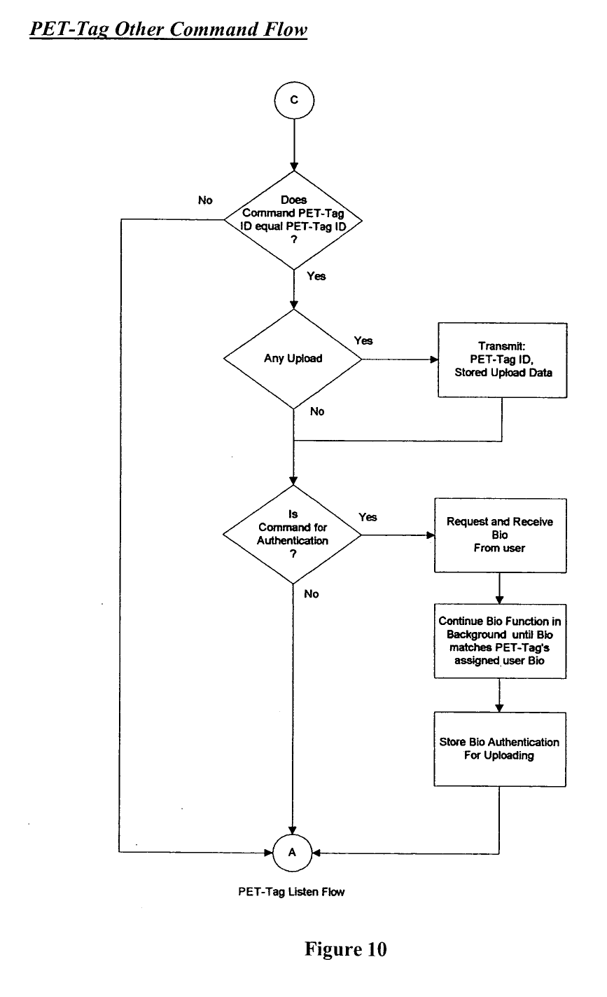

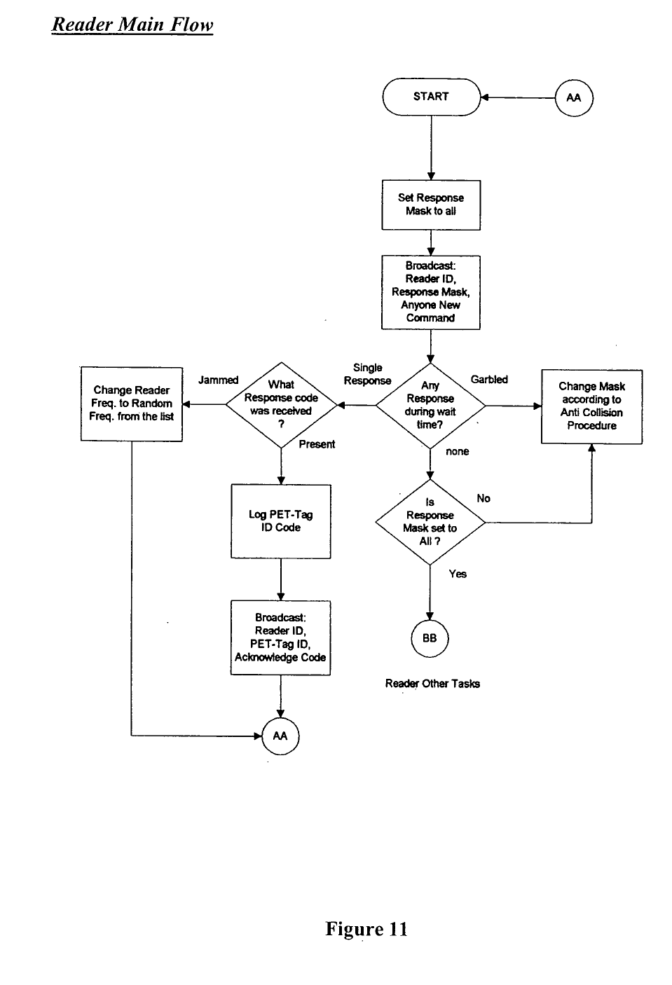

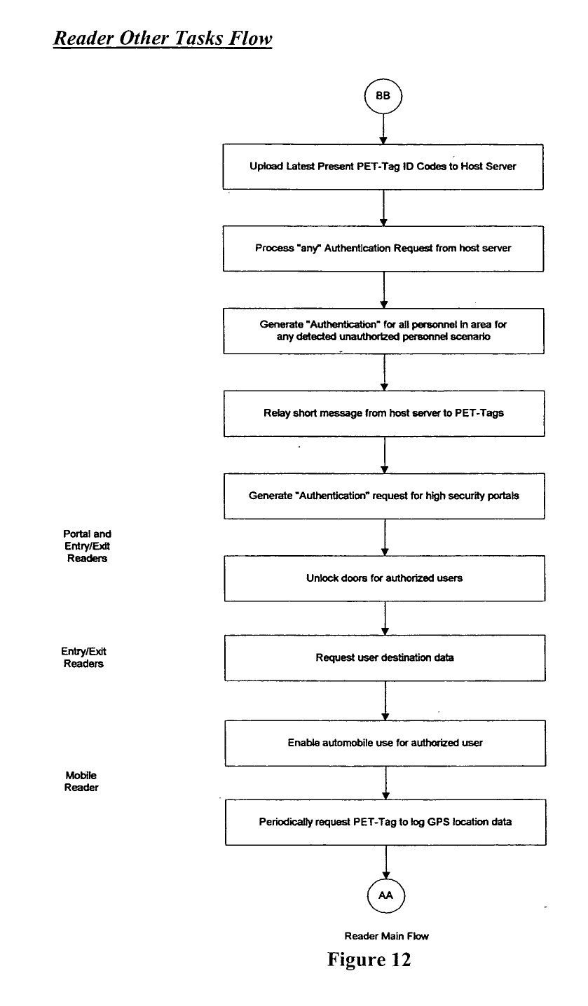

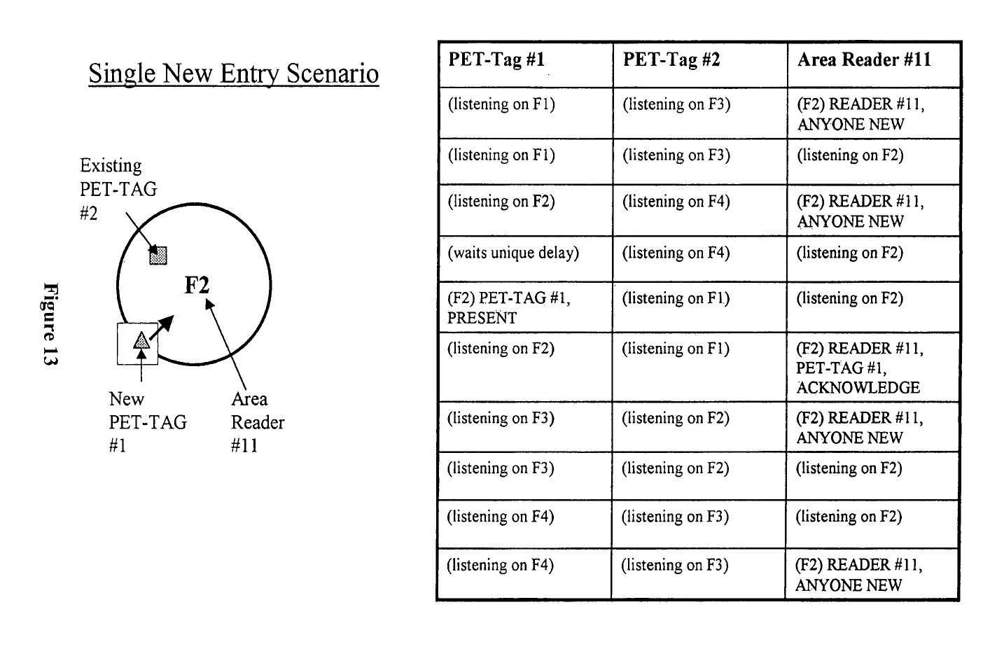

In the preferred embodiment of the people tracking system, the PET-tags and area readers interact using the flowcharts shown in FIGS. 7-12. FIGS. 7-10 contain the procedure for the PET tag and FIGS. 11-12 contain the procedure for the area readers. These procedure flowcharts were created to allow successful PET tag/area reader communication under a variety of configurations. Specifically, the various steps in the procedures for the PET tag and area reader were included to assist in handling one or more of the six scenarios shown in FIGS. 13-18. In following sections, the manner in which the procedures outlined in FIGS. 7-12 solve each of these challenging configurations will be discussed.

Single New Entry Scenario:

The first configuration shown in FIG. 13 is the case of a single PET tag entering the read range of a single area reader that already contains another PET tag. A summary of interaction between the PET tags and the area reader is shown on the right in the figure. For this discussion, we will assume that the area reader is operating on frequency F2.

The “Reader Monitor Loop” flowchart shown in FIG. 11 indicates that the area reader cycles between broadcasting the “Reader #11, Anyone new” message and listening for responses. If no response is heard, then the “Other Reader Tasks” flowchart shown in FIG. 6 is executed. After processing the other tasks, the reader returns to the top of the “Reader Monitor Loop” and starts again.

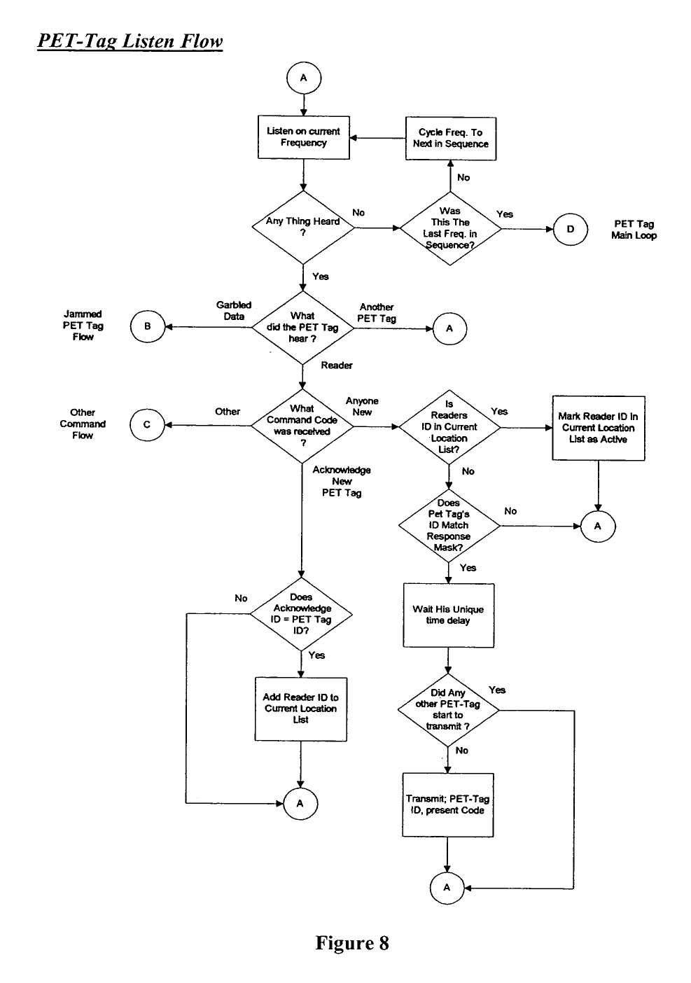

While the area reader is cycling through its procedures, the PET tag is following the procedures outlined in FIGS. 7-10. The PET tag begins with the “PET-Tag Main Loop” procedure shown in FIG. 7. After performing the autonomous tag functions and initialization procedures, the PET-tag is set to begin monitoring the first frequency (F1). The “PET Tag Listen Flow” procedure shown in FIG. 8 describes how the PET tag responds to what it hears. Since the in-range area reader is broadcasting on F2 and the PET-tag is listening on F1, nothing is heard and thus the PET tag will increment its frequency to the next frequency in the frequency list.

Now the PET tag is listening on F2 while the area reader is broadcasting the “Anyone New” message on F2. After the PET tag hears the “Anyone New” message, the PET tag waits a unique delay. The purpose of this delay will be discussed below in the “Double New Entry Scenario” case. Since no other PET tag begins transmitting during the delay, the PET-Tag then responds “PET TAG #1, PRESENT” on F2. The PET tag goes back into listening on F2 mode. After receiving the “PET TAG #1, PRESENT” message the area reader responds with the “READER #11, PET TAG #1, ACKNOWLEDGE” message to inform the PET tag that the Area reader received the message. The PET tag then adds the area readers ID code to its current location list. As will be discussed below, the PET tag can be simultaneously within range of more than one reader and thus, the PET tag needs to keep a list of these reader IDs so that the PET tag will not be constantly responding to the “Anyone New” messages.

So why didn't the existing PET Tag #2 (shown as a gray square in FIG. 13) respond to any of the “READER #11, ANYONE NEW” messages?. The simple answer is PET Tag #2 knew that it was not a new tag to reader #11 because area reader ID #11 was already in its current location list and thus it would not respond. Hence, as illustrated in the middle column on the right in FIG. 13, PET Tag #2 continually cycles through the frequency sequence without responding. This ability of the PET tag to only respond when it is a new tag keeps the amount of communication to a minimum, allowing the PET tag to conserve power by only transmitting when it is moved within range of a new area reader. Because existing PET tags do not respond to “ANYONE NEW” messages for the remaining 5 scenarios we can disregard any existing tags within the read ranges.

Double New Entry Scenario:

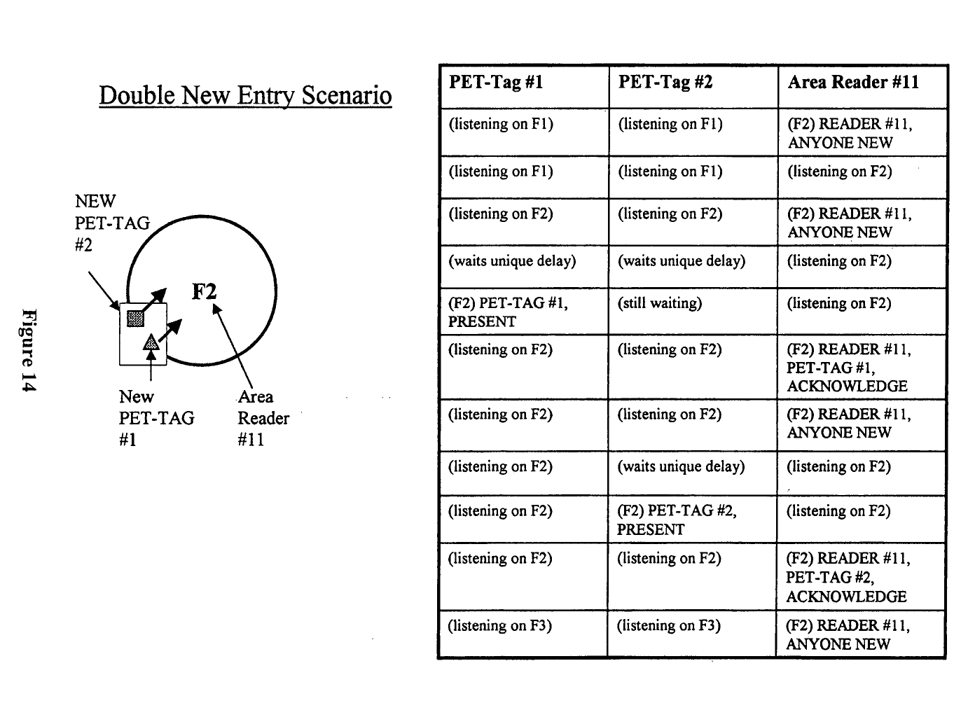

The second scenario shown in FIG. 14 is the case of two PET tags simultaneously entering the read range of a single area reader. Again, a summary of interaction between the PET tags and the area reader is shown on the right in the figure.

There are two cases to consider. The first case is when the two PET tags are “in-phase” with regard to the listening sequence. The second case is when the two PET tags are “out-of-phase” with regard to the listening sequence. The first case is the interesting one to consider.

For this discussion, we will assume that the area reader is operating on frequency F2 and both PET tags are currently listening on frequency F1. Since the in-range area reader is broadcasting on F2 and the PET-tags are listening on F1, nothing is heard and thus the PET-tags will increment their frequencies to the next frequency in the frequency list. When two tags are listening to the same frequencies at the same time is called “in-phase”.

Now the PET tags are both listening on F2 while the Area reader is broadcasting the “Anyone New” message on F2. After the PET tags both hear the “Anyone New” message, the PET tags each wait their unique delay. Now the purpose of this unique delay becomes clear. The PET tag with the shorter delay will stop listening first and because this PET tag thus did not hear any other PET tag, it will respond with “PET TAG #1, PRESENT”. The other PET tag (assumed to be #2 for this discussion) had the longer delay and was still listening when the first PET tag began responding. Thus, the second PET tag does not respond to this “ANYONE NEW” message and goes back to the beginning of the “PET Tag Listen Flow” procedure to await the next “ANYONE NEW” message.

After the first PET tag responded with “PET TAG #1, PRESENT” it went back to listening on frequency F2. After receiving the “PET TAG #1, PRESENT” message the Area reader responds with the “READER #11, PET TAG #1, ACKNOWLEDGE” message to inform the PET tag that the Area reader received the message. The PET tag then adds the Area reader's ID code to its current location list.

After acknowledging the first PET tag, the area reader then goes back to the “Reader Monitor Loop” flowchart and broadcasts the “ANYONE NEW” message on F2 again. Again, both PET tags hear this broadcast but the first tag ignores the message because this reader ID code #11 is already in its current location list. The second PET tag again waits its unique delay, but this time no other tag begins transmitting during the delay. Hence, the second PET tag responds with “PET-TAG #2, PRESENT” and goes back to listening on F2. Now after the area reader receives this present message, the area reader responds with the “READER #11, PET TAG #2, ACKNOWLEDGE” message to inform the PET tag that the area reader received the message. The second PET tag then adds the Area reader's ID code to its current location list.

This example illustrates how the “waiting a unique delay” prevents more than one PET tag from responding simultaneously. Thus, this “waiting a unique delay” feature resolves the multiple “in-phase” new PET-tag situation.

The multiple “out-of-phase” new PET tag situation is essentially the same as back-to-back single new entry scenarios. That is, as each PET tag cycles through the area reader frequency, this PET tag will be the only one responding to the “ANYONE NEW” because the other PET tags were listening on other frequencies.

Jammed Reader Scenario:

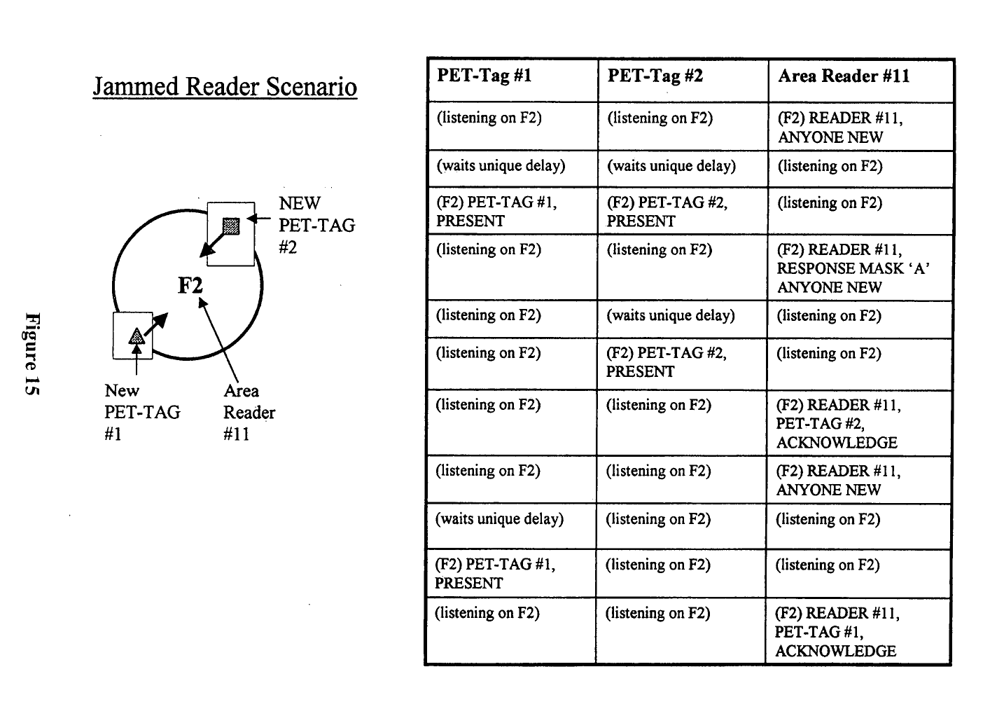

The third scenario shown in FIG. 15 is the case of two PET-tags simultaneously entering the read range of a single area reader from opposite sides. Again, a summary of interaction between the PET-tags and the area reader is shown on the right in the figure. Again, only the “in-phase” case is the interesting one to consider.

This case is different from the previous double entry scenario in that when PET-Tags are at opposite extremes of the read range, one PET tag might not hear the other PET tag respond to the “ANYONE NEW” message. Hence, both PET tags might respond nearly simultaneously and the reader will receive garbled data. When two or more readers are transmitting at the same time on the same frequency, it is called a “Jammed Reader”.

When the area reader receives garbled data in response to an “ANYONE NEW” broadcast, the area reader assumes that two or more PET tags are trying to respond and that it needs to utilize an anti-collision procedure. One suitable anti-collision approach is to use a response mask. The common “ANYONE NEW” message that has been discussed at length in the previous cases actually contains a response mask code. Usually the response mask is set to ‘all’. During the anti-collision procedure, the response mask is changed sequentially to a series of binary mask patterns. Only PET tags whose unique ID code is consistent with the received response mask will respond. In this manner, the area reader will cycle through the series of binary anti-collision response masks until only one PET tag responds to the “ANYONE NEW” message.

To illustrate this anti-collision procedure consider the example interaction shown on the right in FIG. 15. When the two “in-phase” PET tags start listening on frequency F2, they both hear the “READER #11, ANYONE NEW” message. The PET tags each wait their unique delay, and then assuming Tag #1 has the shorter unique delay it responds with “PET TAG #1, PRESENT”. But, since PET Tag #2 cannot hear PET Tag #1, it responds with “PET TAG #2, PRESENT”. The area reader hears both of these overlapping responses as garbled data. The area reader, then enter the anti-collision mode. The area reader then broadcasts, “READER #11, RESPONSE MASK ‘A’, ANYONE NEW”. As mentioned above, the response masks are binary masks. The first mask in the sequence is ‘11111110’ (assuming only 8 bit ID codes). This response mask is equivalent to “respond if your ID code is an even number”. Thus, only PET Tag #2 will respond. The area reader will hear the “PET TAG #2, PRESENT” message and will then respond with “READER #11, PET TAG #2, ACKNOWLEDGE”. PET Tag #2 receiving the “ACKNOWLEDGE” message will add reader ID #11 to its current location list. After a successful communication, the area reader resets the response mask back to all. On the next “ANYONE NEW” message, PET TAG #2 will not respond because its current location list already contains #11 and thus only PET Tag #1 will respond. The area reader receives the “PET TAG #1, PRESENT” message and will then respond with “READER #11, PET TAG #1, ACKNOWLEDGE”.

Overlapped Reader Scenario:

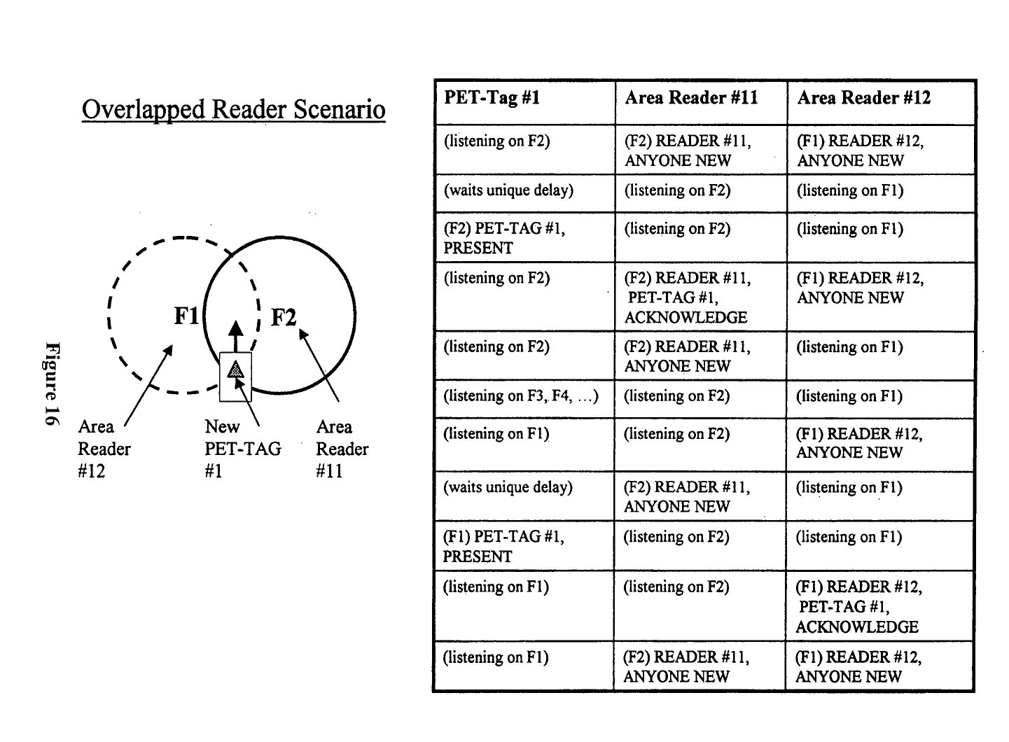

The fourth scenario shown in FIG. 16 is the case of a single PET tag entering the read range of a two overlapped area readers.

Again, a summary of the interaction between the PET tag and the area readers is shown on the right in the figure.

As was illustrated in FIGS. 5 and 6, the read ranges of adjacent area readers are commonly overlapped to avoid dead zones. Hence, this scenario is probably fairly common.

To illustrate this scenario, consider the case where area reader #11 is operating on frequency F2, and area reader #12 is operation on frequency F1. As PET Tag #1 enters the read range of both readers, the PET is currently monitoring frequency F2 and thus only hears the “READER #11, ANYONE NEW” message. The PET tag responds with “PET TAG #1, PRESENT” and reader #11 responds with “READER #11, PET TAG #1, ACKNOWLEDGE”. After completing the dialog with READER #11, PET Tag #1 sequentially listens on frequencies F3, F4. After reaching the end of the list of frequencies, the PET Tag is reset back to the beginning of the sequence as shown in the “PET Tag Main Loop” flowchart shown in FIG. 7.

Since the PET tag is now monitoring frequency F1, it hears the “READER #12, ANYONE NEW” message. The pet tag responds with “PET TAG #1, PRESENT” on frequency F2 and reader #12 responds with “READER #12, PET TAG #1, ACKNOWLEDGE”.

This scenario illustrates how the use of different frequencies between neighboring readers avoids any communication conflicts. The next example will show how the people tracking system can handle the troublesome case of overlapped readers operating on the same frequency.

Jammed PET Tag Scenario:

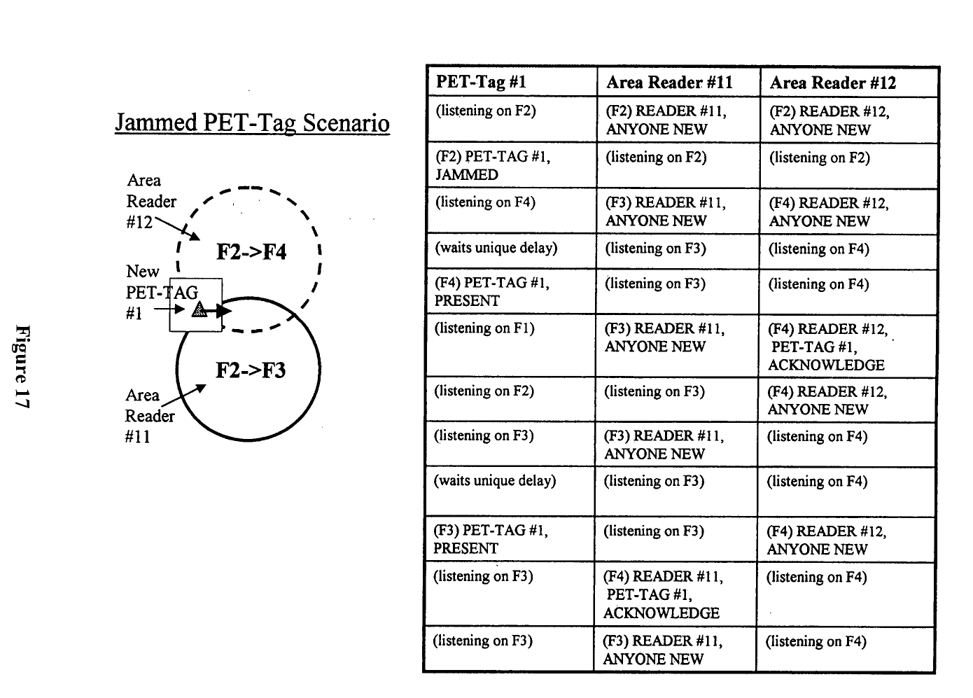

The fifth scenario shown in FIG. 17 is the case of a single PET tag entering the read range of two overlapped area readers operating on the same frequency. Again, a summary of the interaction between the PET tag and the area readers is shown on the right in the figure.

Because, as illustrated in FIGS. 5 and 6, the read ranges of adjacent area readers are commonly overlapped to avoid dead zones, the people tracking system requires that either readers be deployed in a manner to prevent adjacent readers operating on the same frequency or that the people tracking system be able to detect this situation and effectively deal with it. The PET tag flowcharts shown in FIGS. 7-10 and the area reader flowcharts shown in FIGS. 11-12 are designed to detect this problem and correct the situation.

To illustrate the manner in which the people tracking system handles this scenario, consider the case where area reader #11 is operating on frequency F2, and area reader #12 is also operating on frequency F2. As PET Tag #1 enters the read range of both readers, the PET is currently monitoring frequency F2. Two possibilities exist—either the two readers are “in-phase” or “out-of-phase”. Readers are denoted “in-phase” if they are transmitting the “ANYONE NEW” messages at the same time and “out-of-phase” if one transmits while the other one is listening. The “in-phase” case is the troublesome case.

Assume the readers are “in-phase”, the PET tag will receive the “ANYONE NEW” messages from both readers nearly simultaneously and thus the data will be garbled. When a PET tag receives garbled data, it assumes that two or more area readers are transmitting on the same frequency. The PET Tag responds to the garbled data by broadcasting the “PET TAG #1, JAMMED” message on frequency F2. This “JAMMED” message will be received by both area reader #11 and #12. Upon receipt of the “JAMMED” message both area readers change their frequency to a new frequency chosen at random from the frequency sequence. For this example, reader #11 chose F3 and reader #12 chose F4. If the two readers chose the same random frequency, the PET tag would be jammed again during the next pass and this process would repeat until different frequencies were selected in the random process or the PET tag exits the read range of one of the area readers.

An alternative to totally random frequency changes, it might be more useful to assign each reader during installation a “secondary” frequency to use during the “Jammed PET” scenario.

After the two area readers have shifted to different frequencies, then the PET tag sequentially receives and responds to first one area reader and then the other area reader in a similar manner to the process outlined in the “overlapped reader” scenario discussed above.

This scenario illustrates how the intelligent PET tag can detect that two or more area readers are jamming the communication channel. In addition to detecting this problem, the PET tag can signal the area readers that this problem exists and the area readers can adjust their frequency to alleviate this situation. The alternative to having the system shift frequencies automatically would be for the area readers to relay this “JAMMED” PET signal to the host server for attention by system personnel. Even in the automatic adjustment mode, the “JAMMED” PET signals should be logged with the host server so that system personnel can look for patterns that might indicate deployment issues such as too many area readers overlapping possibly due to incorrect power level settings or poor placement, etc.

Jammed Reader & PET Tag Scenario:

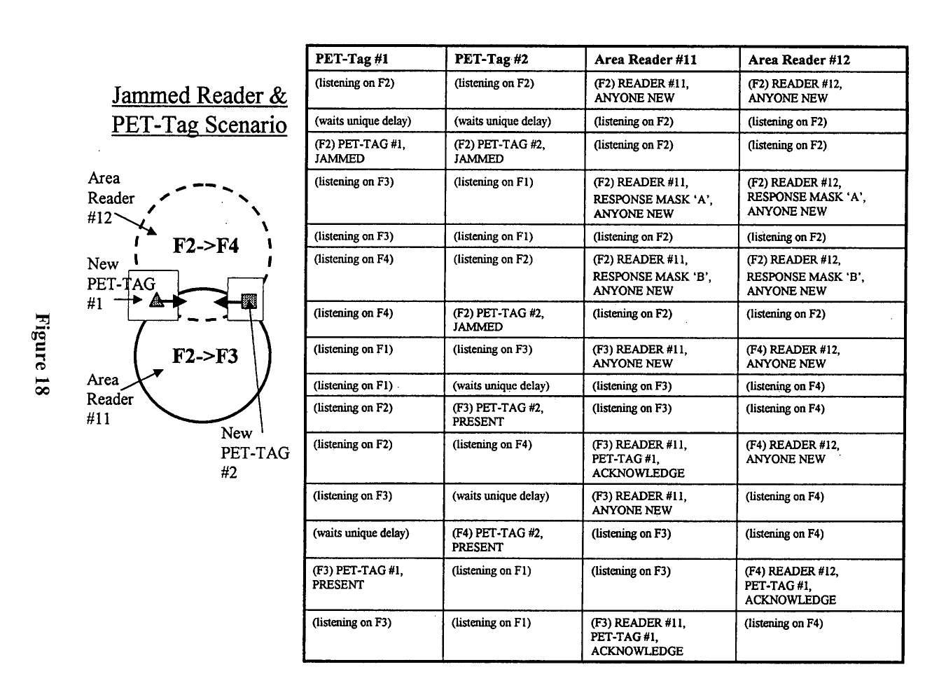

The sixth and final scenario shown in FIG. 18 is the case of two PET tags entering from opposite sides the overlapped read range of two area readers operating on the same frequency. This is essentially the combination of the “Jammed Reader” (shown in FIG. 15) and the “Jammed PET Tag” (shown in FIG. 17) scenarios. Again, a summary of the interaction between the PET tags and the area readers is shown on the right in the figure.

While overlapped area readers will be common in the people tracking system, adjacent area readers are supposed to be deployed on different frequencies. So, the “JAMMED PET Tag” scenario should be a rare event. On the other hard, while multiple PET tags will exist within the range of a reader, typically only one new PET tag will be entering the read range. Thus, this last scenario of both the readers and the PET Tags being simultaneously jammed is considered highly unlikely. However, we have designed the PET tag flowcharts shown in FIGS. 7-10 and the area reader flowcharts shown in FIGS. 11-12 to detect and alleviate this situation.

As was discussed above in the “Jammed PET tag” scenario, the case of “in-phase” area readers is the troublesome case. Also, as was discussed above in the “Jammed Reader” scenario, the case of “in-phase” PET-tags is the troublesome case. Hence, this double “in-phase” case is the troublesome case for this scenario.

To illustrate the manner in which the people tracking system handles this scenario, consider the case where area reader #11 is operating on frequency F2, and area reader #12 is also operating on frequency F2. As PET Tags #1 and #2 enter the overlapped read range from opposite sides, both PET tags are currently monitoring frequency F2. Both PET tags receive the “ANYONE NEW” messages from both area readers as garbled data. Upon receiving garbled data, each PET tag assumes that a “JAMMED PET tag” scenario exists. Each PET tag waits its unique delay before broadcasting the “PET Tag XX, JAMMED” message. After broadcasting the “JAMMED” message, each PET tag switches to a new random position in the frequency listening sequence. Notice that each PET tag is unaware of the presence of the other PET tag.

Because the two PET tags entered the overlapped read range from opposite extremes, each PET tag might not hear the broadcast from the other, so the two “JAMMED” broadcasts will be received as garbled data by the area readers. The two area readers independently conclude that they are operating in the “JAMMED READER” scenario. Notice that each reader is effectively unaware of the presence of the other reader.

At this point the two readers believe that they are in a “JAMMED READER” situation and begin trying to resolve the responses from the two PET tags using the response mask mechanism. However, because the readers are unaware of the presence of the other reader, the readers' messages are constantly being received as garbled data by any PET tags. The key to resolving this dilemma is the PET tags switching to a new random position in the frequency listening sequence. Now, the next time one of the two PET tags cycles back to frequency F2, only one PET tag broadcasts the “JAMMED” message and then both readers realize that in fact the “JAMMED PET tag” scenario also exists and the two area readers switch to a new, random frequency from the frequency list.

For this illustration, area reader #11 switches from frequency F2 to F3, and area reader #12 switches from frequency F2 to F4. At this point, both area readers are operating on different frequencies, both PET tags are “out-of-phase”, and the two PET tags will successfully answer the “ANYONE NEW” messages and receive “ACKNOWLEDGE” messages from the two area readers as shown in the table on the right side of FIG. 18.

This scenario, while unlikely to occur in practice, shows that the people tracking system procedures as outlined in FIGS. 7-12 are quite robust.

PET tag:

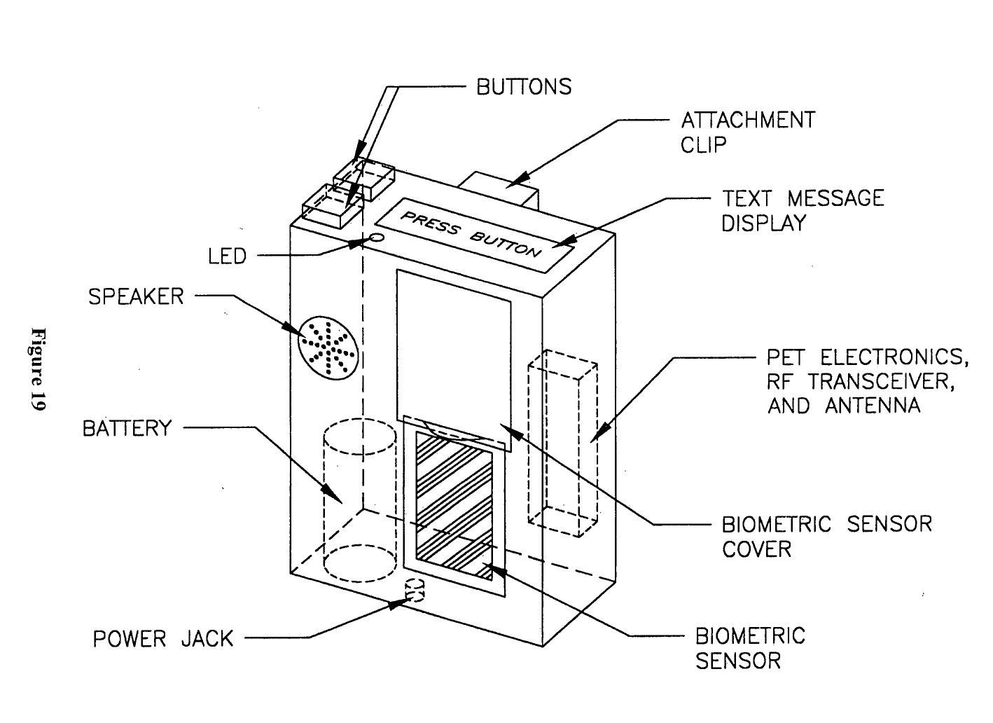

The basic functionality of the PET tag is illustrated in FIG. 2 and was described above. In the preferred embodiment shown in FIG. 19, the PET tag is in a small package the size of a pager. On the back of the unit is an attachment clip to allow the user to clip the PET tag to his belt. On the top of this unit is the text display, notification led and input buttons. On the front is the speaker and biometric sensor. The biometric sensor may be protected using a sliding or folding sensor cover. Internal to the unit is the PET tag electronics (i.e. microprocessor, memory and transceiver antenna) and the battery. On the bottom of the unit is a power jack for recharging the internal battery.

Other form factor embodiments of the PET tag are envisioned. For example, a PET tag could be constructed in the form factor of a pen, badge or a cell phone. Each of these form factors would be attractive from different useability considerations. For example, some office environments already require users to wear an ID badge either on a strap around their neck or clipped to the exterior of their clothing. Clearly, the badge form factor would integrate easily into this environment.

Area Readers:

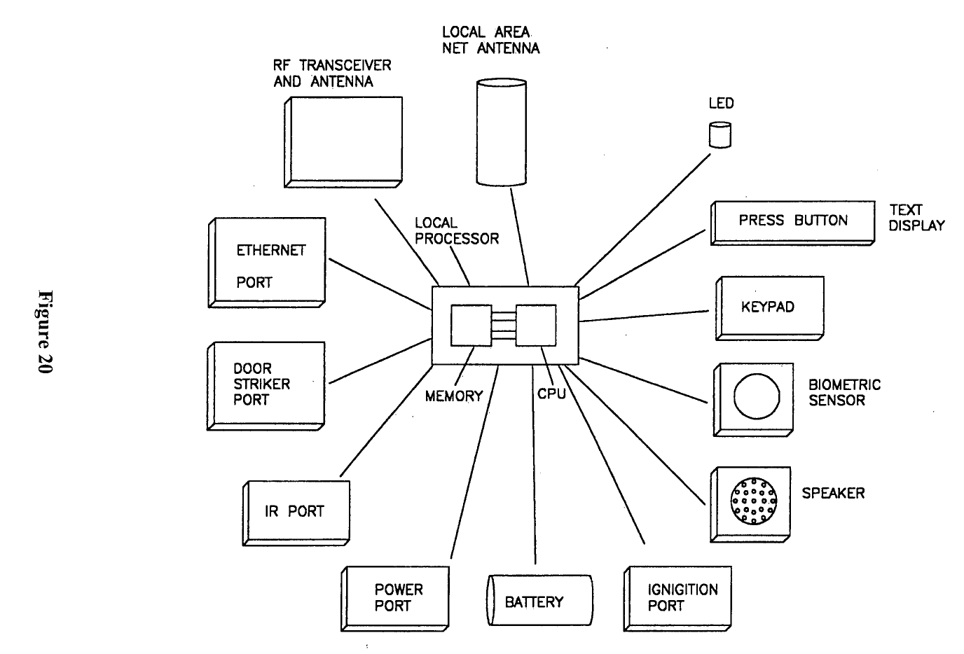

The basic functionality of the area reader is shown schematically in FIG. 20. Comparison of FIGS. 2 and 20 shows that area readers and PET tags have many features in common with also some major differences.

At the core of the area reader is a microprocessor with its associated circuitry and memory. While the area reader logs tag event data with the host server, the area reader keeps a local inventory of current tags as well as a copy of the relevant authorized tag database in its local memory. This enables the area reader to function for a period of time while communication is down between the area reader and the host server.

The area reader is connected to the host server through a local area network. To support flexible deployments, the area reader may contain both a wired and wireless Ethernet port. In addition, the area reader contains RF transceiver electronics and antenna suitable for communication with the PET tags. Also, the area reader may contain an IR port suitable for fast data communication (uploads and downloads) between nearby PET tags and the area reader. The IR port would enable the quick transfer of code updates to the PET tag and the fast transfer of logged event and location data from the PET tag.

The area reader is designed to run from both wall power and from an internal backup battery. The backup battery is to enable smooth functionality during power outages of modest duration.

The area reader has a display, led, speaker and keypad for user input/output. In addition, the area reader also contains a biometric sensor. This biometric sensor can provide much of the biometric authentication function. For example, when a user must authenticate, instead of using the biometric sensor on his PET tag, he could use the biometric sensor on the nearest area reader. This would allow some or all PET tags to be constructed without biometric sensors. This may enable commercial success in lower price point markets.

Lastly, the area reader contains electronics for controlling door strikers and automobile ignitions. The door striker controls would commonly be included on portal readers while the automobile ignition controls would commonly be included on mobile readers.

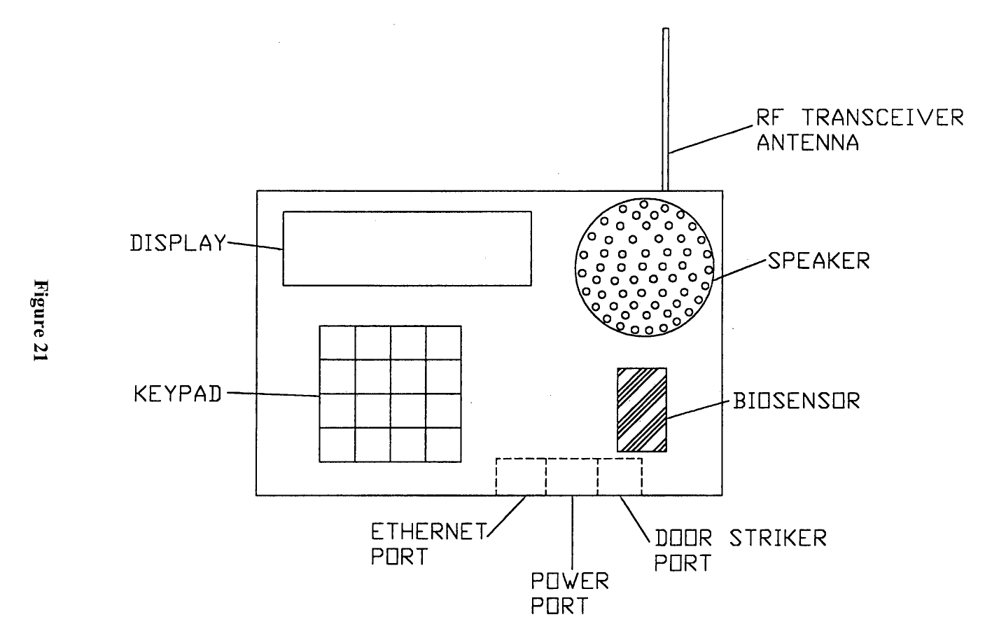

In FIG. 21, the preferred embodiment of a portal type area reader is shown. The reader is a wall mountable unit. The RF transceiver antenna is mounted on the top of the unit for maximum range and sensitivity. The front of the unit contains the display, keypad, speaker and biosensor. On the bottom of the unit are the ports for Ethernet, power and the door striker.

Other form factor embodiments of area readers are envisioned. For example, a general area reader could be constructed in the form factor of a smoke alarm for convenient ceiling mounting. Also, area readers could be constructed in desktop or wall mount form factors.

What is claimed is:

1. A method of tracking and controlling the movements of individuals in a monitored area comprising the steps of:
(a) providing each individual with an electronic personal event tracking (PET) tag having a transceiver and a unique identification code;
(b) providing electronic area readers in the monitored area, each area reader including a transceiver capable of communication with the PET tags of individuals within the vicinity of the area reader;
(c) establishing a communications link between the area readers and a host server;
(d) monitoring the detections by area readers of PET tags as individuals provided with the PET tags move about between the vicinities of the area readers; and
(e) processing the monitored detections to track the movements of the individuals within the monitored facility.

2. The method of claim 1 and wherein step (d) includes periodically broadcasting a signal from each of the area readers, the signal being received by PET tags within the vicinity of each area reader and causing the PET tags to respond with a reply signal that includes their unique identification codes to indicate their presence within the vicinity.

3. The method of claim 1 and wherein there are restricted areas within the monitored facility and wherein the method further includes detecting the presence of PET tags approaching a restricted area and denying access if a detected PET tag is assigned to an individual not authorized to enter the restricted area.

4. The method of claim 3 and wherein the host server is operatively coupled to the locking mechanism of a door to the restricted area and wherein the step of denying access comprises locking the door.

5. The method of claim 1 and further comprising providing a biometric sensor on each PET tag and periodically requiring the individuals wearing the PET tags to provide biometric input to the biometric sensors of their PET tags to insure that PET tags are being worn by their assigned individuals.

6. The method of claim 5 and wherein the biometric sensors are fingerprint readers.
